(19) United States
(12) Patent Application Publication
(10) Pub. No.: US 2026/0246325 A1
(43) Pub. Date: Aug. 20, 2026

(54) ROTOR, ELECTRIC MACHINE AND KIT OF PARTS

(71) Applicant: Schaeffler Technologies AG & Co. KG, Herzogenaurach (DE)

(72) Inventor: Jean-Francois HELLER, Strassburg (FR)

(73) Assignee: Schaeffler Technologies AG & Co. KG, Herzogenaurach (DE)

(21) Appl. No.: 19/164,694

(22) PCT Filed: Feb. 26, 2024
(86) PCT No.: PCT/DE2024/100151

§ 371 Date: Sep. 12, 2025

(30) Foreign Application Priority Data
Mar. 15, 2023 (DE) 10 2023 106 507.6

(51) Int. Cl. H02K 1/276; H02K 7/00

(52) U.S. Cl. CPC H02K 1/276; H02K 7/003; H02K 2213/09

(57) ABSTRACT

A rotor for an electric machine wherein: the rotor comprises at least a first rotor body having a first group of permanent magnets, and a second rotor body having a second group of permanent magnets; the first rotor body and the second rotor body can be rotated relative to one another about a common axis of rotation, against the effect of a first torsional stiffness mechanism, by a mechanical field-attenuation mechanism having a first mechanical stop which limits the rotation of the two rotor bodies relative to one another in a first circumferential direction, and a second mechanical stop which limits the rotation of the two rotor bodies relative to one another in a second circumferential direction.

### CROSS-REFERENCE TO RELATED APPLICATIONS

This application is the U.S. National Phase of PCT Appln. No. PCT/DE 2024/100151, filed Feb. 26, 2024, which claims the benefit of German Patent Appln. No. 102023106507.6, filed Mar. 15, 2023, the entire disclosures of which are incorporated by reference herein.

### TECHNICAL FIELD

The disclosure relates to a rotor for an electric machine, in particular for use within a drive train of a hybrid-electric or fully electric motor vehicle, wherein the rotor has at least a first rotor body with a first group of permanent magnets and a second rotor body with a second group of permanent magnets, and to an electric machine and a kit-of-parts.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, 05/2011, pages 360-365 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which is probably the closest prior art. This article describes a drive unit for an axle of a vehicle, which comprises an electric motor arranged to be coaxial to a bevel gear differential. Such drive units are also referred to as e-axles or electrically operable drive trains.

Electric machines are subject to losses during operation due to magnetic reversal, which are grouped together as iron losses and reduce the machine efficiency. In mobile applications, low efficiency of the electric machine means a reduced range of the vehicle or increased demand for battery capacity. It is therefore an ongoing goal, especially in mobile applications with purely electric drive, to minimize the iron losses described.

An example of such an electric machine with iron losses, as it can be used within a drive train of a hybrid-electric or fully electric motor vehicle, is what is termed the permanently excited synchronous machine. Due to its high power density compared to other types of machines, it is preferred for use in the field of electromobility, where the available installation space is often a limiting factor. The excitation field of the machine is usually generated by permanent magnets that are arranged in the rotor of the machine. In a permanently excited synchronous machine, it is possible to dispense with a slipring contact which is necessary in electrically excited synchronous machines to supply power to an excitation coil arranged on the rotor.

However, a disadvantage of permanent excitation is that the excitation field cannot be easily modified. In principle, a synchronous machine can be operated beyond its rated speed by controlling what is termed the field-attenuation range. In this range, the machine is operated at its maximum rated power, with the torque delivered by the machine decreasing as the speed increases. Electrically excited synchronous machines can be operated very easily in the field-attenuation range by reducing the excitation current. Even in the case of permanently excited machines, there are known ways of generating an air gap field component by means of a suitable current supply to the stator of the machine, which counteracts the excitation field generated by the permanent magnets and thus weakens it. However, such control of the machine causes increased losses, so that the machine can only be operated with a reduced efficiency in this range.

An effective method for reducing iron losses in electric machines is to deliberately weaken the magnetic field between stator and rotor for operating points with high speeds, since the losses due to high-frequency magnetic reversal are lower with a weaker magnetic field. In addition to electrical approaches, there are also mechanical approaches for targeted field attenuation. From the patent specifications US58211710, FR2831345, EP1085644, EP11867030, DE1012011708670, DE1012016103470, CN104600929, and CN105449969, a rotor of a radial flux machine is known which is divided in a manner perpendicular to the axis of rotation into several rotor discs equipped with permanent magnets and which can be rotated relative to one another. Depending on the relative rotation between the rotor discs, the rotor provides the full magnetic field in a position with the magnetic poles aligned in the axial direction and a weakened magnetic field in a position rotated relative to this. Active or passive mechanisms are described which claim to be able to switch between these two positions depending on the rotor speed or torque and thus enable more efficient operation of the electric machine over the entire engine characteristic map.

DE 10 12021 101 898 describes an arrangement in which the rotor of a radial flux machine is divided into two rotor parts, the individual rotor discs of which alternate in the axial direction. One rotor part is directly connected to the rotor shaft, the other rotor part is connected to the rotor shaft in a torque-transmitting manner via a torsional stiffness mechanism. The torsional stiffness mechanism is selected in such a way that, at low torque, a torsional position of the rotor parts with a weakened magnetic field prevails and, at high torque, a torsional position of the rotor parts with a full magnetic field prevails. DE 10 12021 101 904 claims a structurally designed mechanical module that can be introduced into the interior of the permanent magnet-equipped rotor discs, establishes the described connections of the rotor parts and the rotor shaft, and allows a variable speed characteristic to be defined via the torsional stiffness mechanism, which is achieved with springs and roller-equipped cam drives.

### SUMMARY

All previously mentioned passive solutions, which use a torque as a sensor variable to trigger a relative rotation between two rotor parts against a torsional stiffness mechanism, assume that the total electromagnetic torque generated by the stator current supply in the case of the initially field attenuated position with non-aligned magnetic poles is simply distributed between the two rotor parts, approximately according to their share of the total length and according to their respective phase positions with respect to the stator field, regardless of the presence of the other rotor part. Only then could a partial torque proportional to the total torque be easily directed against a torsional stiffness mechanism between the rotor parts or one of the rotor parts and the rotor shaft and bring about the desired rotation with increasing torque into the position with full magnetic field with aligned magnetic poles. However, tests and modeling by the applicant have shown that the actual situation is far more complicated.

Even in the de-energized case, there are interactions between the rotor discs of the two rotor parts in the form of magnetic repulsion torques. The position with a full magnetic field and aligned magnetic poles represents a labile equilibrium with vanishing repulsion torque. As the rotation begins from this equilibrium position, a repulsion torque arises which increases with increasing rotation until it reaches a maximum and then decreases again with further rotation. The course of the repulsion torque over the angle of rotation within an electrical period, the height of the maximum, and the angle of rotation at which it occurs depend strongly on the chosen type of arrangement of the permanent magnets within the rotor discs. The course over an electrical period is fundamentally nonlinear.

In the case of the desired efficient stator current supply for different speeds, these magnetic repulsion torques increase in different ways, sometimes several times, depending on the speed. Overall, partial torques result which are not suitable, in any case, to be easily directed against a torsional stiffness mechanism between the rotor parts or one of the rotor parts and the rotor shaft in order to cause a rotation of the rotor parts into the position with a full magnetic field, since they do not point in the right direction for this due to the high proportion of magnetic repulsion torques.

For reliable adjustment behavior, it is necessary, among other things, that the end stops of a mechanical field-attenuation mechanism are precisely defined and designed to be operationally reliable. In order to provide a functional arrangement in the sense of the aforementioned passive solutions for torque-adaptive field attenuation of the rotor of an electric machine, the object of the present disclosure is to provide a rotor and an electric machine with improved mechanical field attenuation. It is also the object of the disclosure to realize a kit of parts for forming a field-attenuation mechanism of a rotor of an electric machine.

The object is achieved by a rotor for an electric machine, in particular for use within a drive train of a hybrid-electric or fully electric motor vehicle, wherein the rotor has at least a first rotor body with a first group of permanent magnets and a second rotor body with a second group of permanent magnets, wherein the first rotor body and the second rotor body can be rotated relative to one another about a common axis of rotation, against the effect of a first torsional stiffness mechanism, by means of a mechanical field-attenuation mechanism, wherein the field-attenuation mechanism has a first mechanical stop which limits the rotation of the two rotor bodies relative to one another in a first circumferential direction, and a second mechanical stop which limits the rotation of the two rotor bodies relative to one another in a second circumferential direction, wherein the field-attenuation mechanism has a hub coupled with the rotor shaft of the rotor for conjoint rotation, wherein the first rotor body is coupled with a first annular stop disc and the second rotor body is coupled with a second annular stop disc, wherein both the first stop disc and the second stop disc are positioned at an end of the first rotor body that points out of the rotor.

This has the advantage that the stops are arranged axially outside the rotor body and the stop discs and the hub in particular can also be coupled to the rotor as a modular assembly group by being pushed axially onto the rotor shaft.

This provides the advantage that an electric machine can be realized with a purely mechanical field-attenuation device, which reliably and cost-effectively adjusts the positions of permanent magnets within the rotor required for field attenuation as required, depending on the operating conditions of torque and speed. In principle, the disclosure thus also avoids the need for actuators to intervene on or in the rotor from the outside.

In principle, it would also be conceivable that a second hub with assigned stop discs is positioned at a second end that points out of the rotor. This allows the stop system of the field-attenuation mechanism to be “mirrored”, for example in order to be able to safely absorb higher stop forces.

The electric machine can in particular be designed as a rotary machine. In the case of electric machines designed as rotary machines, a distinction is drawn in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator. In the context of this disclosure, it is possible that the electric machine is configured as a radial flux machine or axial flux machine.

A rotor is the rotating (spinning) part of an electric machine. The rotor particularly comprises a rotor shaft and one or more rotor bodies formed of rotor lamination stacks which are arranged on the rotor shaft for conjoint rotation. The rotor shaft can be hollow, which, on the one hand, results in a weight reduction and, on the other hand, allows the supply of lubricant or coolant to the rotor body.

A rotor body for the purposes of the disclosure is understood to mean the rotor without a rotor shaft. The rotor body is therefore made in particular of a rotor lamination stack and the permanent magnets inserted into the pockets of the rotor lamination stack or fixed to the circumference of the rotor lamination stack, as well as any axial cover parts for closing the pockets.

The permanent magnets can preferably be inserted into the pockets of the rotor lamination stack. A single larger rotor magnet designed as a bar magnet or a plurality of smaller rotor magnets designed as permanent magnetic elements can be provided for each pocket.

The rotor has a plurality of rotor bodies. Particularly preferably, the rotor bodies are formed substantially of the same parts, in particular substantially identically. It is highly preferred that the rotor bodies are formed from identical, in particular substantially identical rotor laminations. The rotor bodies are therefore particularly preferably formed from a rotor lamination stack, which is composed of a plurality of laminated individual sheets or rotor laminations, usually made of electrical steel, which are layered and stacked one above the other to form a stack, what is termed the rotor lamination stack. The individual laminations can be held together in the rotor lamination stack by gluing, welding, or screwing. A rotor lamination stack can in particular also have permanent magnets that are inserted into the pockets of the rotor lamination stack, or that are fixed circumferentially to the rotor lamination stack.

Mechanical field-attenuation mechanisms are fundamentally known from the prior art. Particularly preferred mechanical field-attenuation mechanisms in the context of the present disclosure are described in DE 102022106 944 and DE 102022106945, which have not yet been published, and in the patent publications of DE 102021101904B3, DE102021101898A1, and DE102021101900A1 and are hereby incorporated by reference in the disclosure of the present application.

It may further be preferred that the first rotor body and the second rotor body are rotatable relative to one another against the effect of a first torsional stiffness mechanism about a common axis of rotation by means of a mechanical field-attenuation mechanism, wherein the first torsional stiffness mechanism is designed as a first torsion spring arrangement having a first torsion spring, which can be arranged coaxially with respect to the axis of rotation and between the first rotor body and the second rotor body or between one of the rotor bodies and a rotor shaft in such a way that the rotation of one of the rotor bodies, which begins during the adjustment of the field-attenuation mechanism, brings about an opening or closing actuation of the first torsion spring.

The design of a torsional stiffness mechanism as a torsion spring arrangement for defining an adjustment characteristic curve for weakening the magnetic field by relative rotation of the rotor bodies allows in particular the reduction of the centrifugal force influence on the adjustment characteristic curve and its hysteresis.

According to an advantageous embodiment of the disclosure, it can be provided that the hub has a plurality of hub teeth projecting outwards in the radial direction, which form/forms the first mechanical stop with the first stop disc and/or the second mechanical stop with the second stop disc. The advantage of this embodiment is that the teeth can be used to define a stop in both circumferential directions. The hub preferably has at least two hub teeth. Most preferably, the number of hub teeth is at least four. Furthermore, the hub teeth are preferably arranged equidistantly around the circumference of the hub. Most preferably, the hub teeth are substantially identical.

According to a further preferred development of the disclosure, it can also be provided that the first stop disc has a plurality of first teeth projecting inwards in the radial direction, which together with at least one of the hub teeth form/forms the first mechanical stop and/or the second stop disc has a plurality of second teeth projecting inwards in the radial direction, which together with at least one of the hub teeth form/forms the second mechanical stop.

This allows the stops to be designed in a particularly advantageous manner in terms of manufacturing technology. In this context, it is preferable to manufacture a stop disc by punching it from a metal sheet. A stop disc preferably has at least two teeth. Most preferably, the number of teeth of a stop disc is at least four. Furthermore, the teeth are preferably arranged equidistantly around the circumference of a stop disc. Most preferably, the teeth of a stop disc are substantially identical.

It is further preferred that the number of hub teeth corresponds to the number of teeth of one stop disc, preferably the number of teeth of both stop discs.

Furthermore, according to another advantageous embodiment of the disclosure, it can be provided that the first stop disc has a plurality of first fixing openings, each of which is penetrated by a first fixing pin, wherein the first fixing pin axially penetrates the first rotor body so that a rotation of the first rotor body causes a rotation of the first stop disc and/or the second stop disc has a plurality of second fixing openings, each of which is penetrated by a second fixing pin, wherein the second fixing pin axially penetrates the second rotor body so that a rotation of the second rotor body causes a rotation of the second stop disc. The first fixing pin and/or the second fixing pin can be designed in particular as a screw.

According to a further particularly preferred embodiment of the disclosure, it can be provided that the first stop disc has a plurality of first access openings through which one of the second fixing pins passes, and the first access openings are designed such that the second fixing pins do not restrict a relative rotation of the first stop disc to the second stop disc,
and/or the second stop disc has a plurality of second access openings through which one of the first fixing pins passes, and the second access openings are designed such that the first fixing pins do not restrict a relative rotation of the first stop disc to the second stop disc. This allows the two stop discs to rotate freely against each other, wherein the stop in the circumferential direction is then provided solely by the teeth of the hub and the stop discs.

Furthermore, the disclosure can also be further developed in such a way that the connection between the rotor shaft and the hub for conjoint rotation is formed by means of a spline. The advantage of this embodiment is that the hub can be pushed onto the rotor shaft particularly easily and a sufficiently high torque transmission capacity can still be achieved.

In an equally preferred embodiment of the disclosure, it can also be provided that the hub is arranged axially outside the first rotor body and the second rotor body on the rotor shaft. This makes it particularly easy to install the hub, as it does not need to be inserted into the rotor body. This also facilitates the modular design of the hub and the stop discs.

It can also be advantageous to further develop the disclosure in such a way that the first fixing pins and/or the second fixing pins are designed as screws.

The object of the disclosure is further achieved by an electric machine, in particular for use within a drive train of a hybrid-electric or fully electric motor vehicle, comprising a rotor according to the disclosure.

Finally, the object of the disclosure can also be achieved by a kit of parts for producing a field-attenuation mechanism of a rotor of an electric machine, comprising
a. a hub which can be coupled to a rotor shaft of the rotor of the electric machine for conjoint rotation,
b. a first annular stop disc which can be coupled to a first rotor body of the rotor and
c. a second annular stop disc which can be coupled to a second rotor body of the rotor,
d. wherein both the first stop disc and the second stop disc can be positioned at an end of the first rotor body that points out of the rotor, wherein a first mechanical stop can be formed between the hub and the first stop disc and a second mechanical stop can be formed between the hub and the second stop disc.

This allows the components necessary for producing the field-attenuation mechanism to be provided in a particularly convenient manner. The kit of parts can, for example, be a packaging unit. Furthermore, it is possible to design the kit of parts as a compilation of separate storage containers for storing the individual components or the respective component groups of the kit of parts.

### BRIEF DESCRIPTION OF THE DRAWINGS

The disclosure is explained in more detail below with reference to figures without limiting the general concept of the disclosure.

In the figures:

FIG. 1 shows an electric machine in a cross-sectional view;

FIG. 2 shows a schematic block diagram of a rotor with a mechanical field-attenuation mechanism;

FIG. 3 shows a rotor in a first axial sectional view;

FIG. 4 shows a rotor in a second axial sectional view;

FIG. 5 shows a first stop disc and a second stop disc in a frontal view;

FIG. 6 shows a hub in a perspective representation;

FIG. 7 shows a rotor shaft in a perspective view,

FIG. 8 shows the first stop disc, second stop disc and hub in a first operating position in a frontal view;

FIG. 9 shows the first stop disc, second stop disc and hub in a second operating position in a frontal view;

FIG. 10 shows the first stop disc, second stop disc and hub in a third operating position in a frontal view.

### DETAILED DESCRIPTION

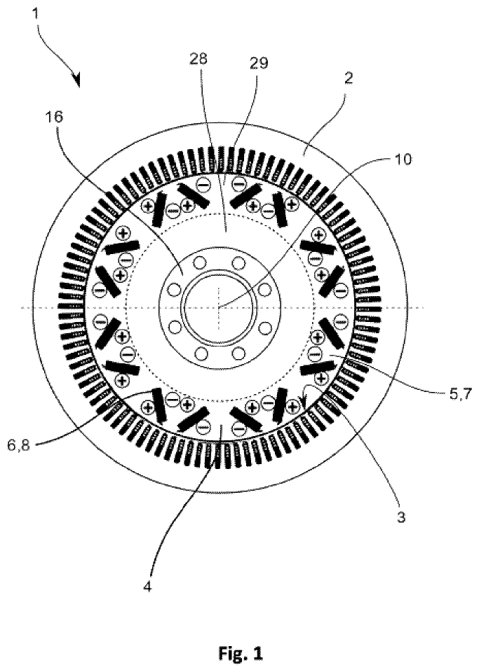

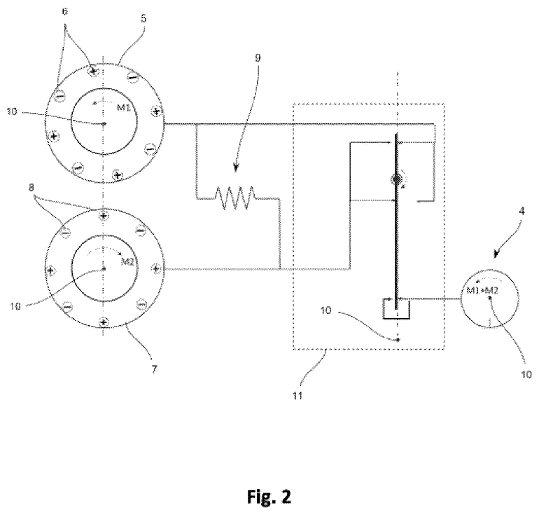

FIG. 1 discloses an electric machine 1, in particular for use within a drive train of a hybrid-electric or fully electric motor vehicle. The electric machine 1 configured as a radial flux machine comprises a stator 2 and a rotor 4 separated from the stator 2 by an air gap 3, the rotor 4 having at least a first rotor body 5 with a first group of permanent magnets 6 and a second rotor body 7 with a second group of permanent magnets 8, which can be easily understood by looking at FIG. 1 together with FIG. 2.

The first rotor body 5 and the second rotor body 7 can be rotated relative to one another about a common axis of rotation 10 by means of a mechanical field-attenuation mechanism 11 against the effect of a first torsional stiffness mechanism 9. The two rotor bodies 5, 7 are formed substantially from identical rotor laminations, and the position and the number of the permanent magnets 6 of the first group and the number of permanent magnets 8 of the second group in the rotor bodies 5, 7 are identical.

The field-attenuation mechanism 11 shown by way of example in FIG. 2 comprises an unspecified lever element which is pivotable about a pivot point, wherein the first rotor body 5 can be coupled to a first lever section and the second rotor body 7 can be coupled to a second lever section of the lever element. The first lever section and the second lever section are arranged on opposite sides of the lever, such that the first rotor body 5 and the second rotor body 7 can be rotated relative to one another by tilting of the lever element for a desired adjustment of the mechanical field-attenuation mechanism 11. This field-attenuation mechanism 11 is described in detail in DE102022106944 and DE102022106945, so reference is made here to these documents in order to avoid repetition.

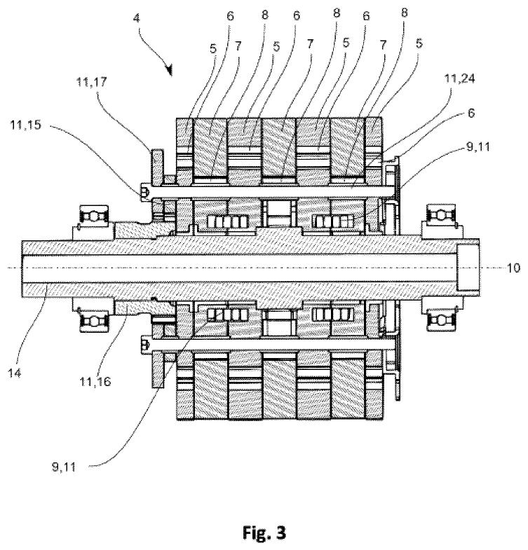

The first torsional stiffness mechanism 9 is designed as a first torsion spring arrangement having a first torsion spring, which is arranged coaxially with respect to the axis of rotation 10 and between the first rotor body 5 and the second rotor body 7 in such a way that the rotation of one of the rotor bodies 5, 7, which begins during adjustment of the field-attenuation mechanism 11, brings about an opening or closing actuation of the first torsion spring. Although it is not shown in FIGS. 2 and 3, it is nevertheless possible for the first torsion spring to also be torque-transmittingly arranged between one of the rotor bodies 5, 7 and the rotor shaft 14.

FIG. 3 shows an embodiment of a rotor 4 for an electric machine 1, wherein the rotor 4 has at least a first rotor body 5 with a first group of permanent magnets 6 and a second rotor body 7 with a second group of permanent magnets 8. The first rotor body 5 and the second rotor body 7 can be rotated relative to one another about a common axis of rotation 10 by means of a mechanical field-attenuation mechanism 11 against the effect of a first torsional stiffness mechanism 9. In the exemplary embodiment shown, a total of four first rotor bodies 5 and three second rotor bodies 7 are present in the rotor 4, wherein the first rotor bodies 5 each form the axial end of the rotor 4.

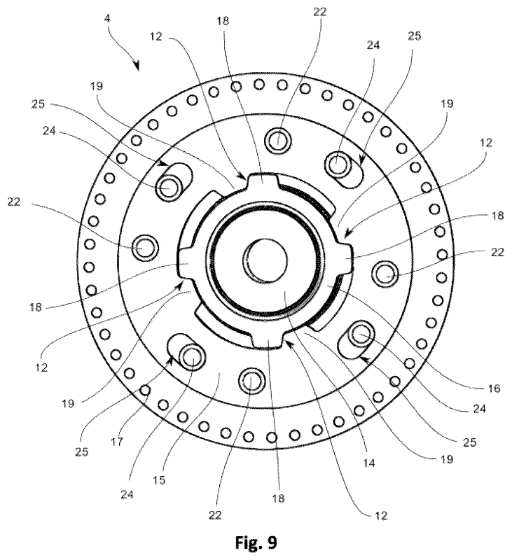

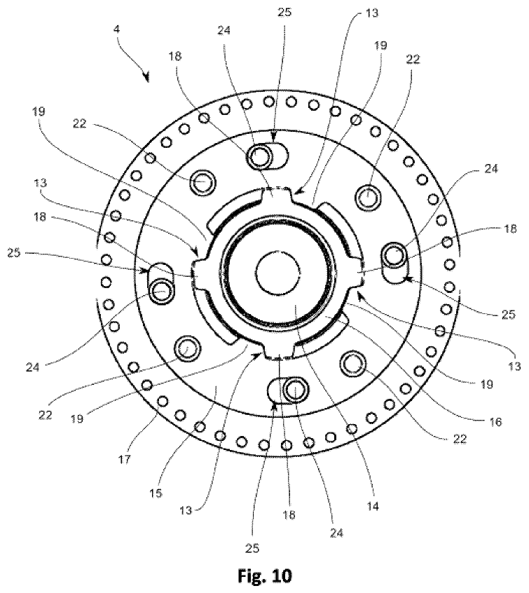

The field-attenuation mechanism 11 has a first mechanical stop 12 which limits the rotation of the two rotor bodies 5, 7 relative to one another in a first circumferential direction, and a second mechanical stop 13 which limits the rotation of the two rotor bodies 5, 7 relative to one another in a second circumferential direction, which can be clearly seen in FIGS. 9 and 10.

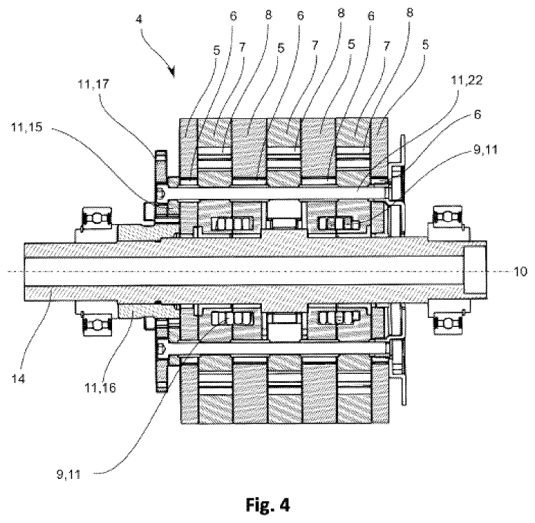

Furthermore, the field-attenuation mechanism 11 has a hub 16 which is coupled to a rotor shaft 14 of the rotor 4 for conjoint rotation, wherein the first rotor body 5 is coupled to a first annular stop disc 17 and the second rotor body 7 is coupled to a second annular stop disc 15, and both the first stop disc 17 and the second stop disc 15 are positioned at an end of the first rotor body 5 that points out of the rotor 4, which can be clearly seen in FIGS. 3 and 4. It can also be clearly seen from FIGS. 3 and 4 that the hub 16 is arranged axially outside the first rotor body 5 and the second rotor body 7 on the rotor shaft 14.

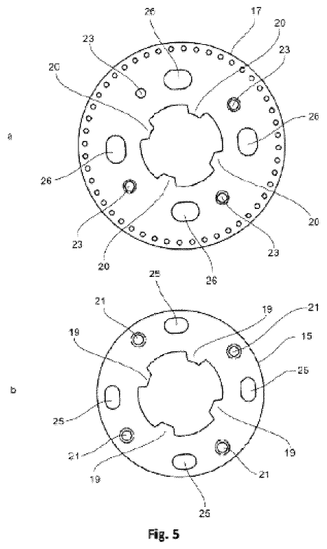

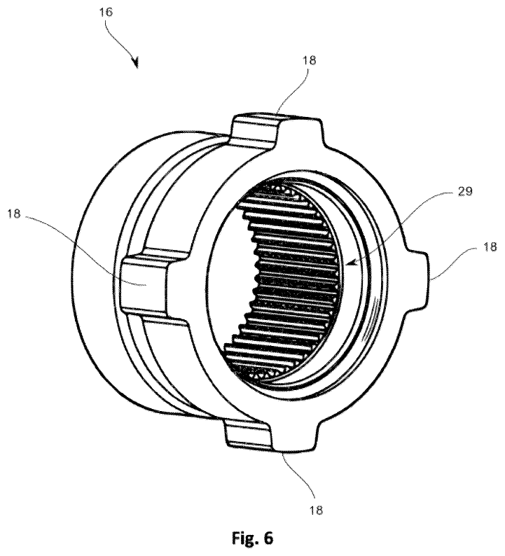

FIG. 6 shows that the hub 16 has four hub teeth 18 projecting outwards in the radial direction, which together with the first stop disc 17 form the first mechanical stop 12 and/or together with the second stop disc 15 form the second mechanical stop 13. FIG. 5 shows that the first stop disc 17 has four first teeth 20 projecting inwardly in the radial direction, which together with at least one of the hub teeth 18 forms the first mechanical stop 12. The second stop disc 15 also has a plurality of second teeth 19 projecting inwardly in the radial direction, which form the second mechanical stop 13 with at least one of the hub teeth 18.

The first stop disc 17 has a plurality of first circular fixing openings 23, each of which is penetrated by a first fixing pin 24, wherein the first fixing pin 24 axially penetrates the first rotor body 5 so that a rotation of the first rotor body 5 causes a rotation of the first stop disc 17 Similarly, the second stop disc 15 has a plurality of second circular fixing openings 21, each of which is penetrated by a second fixing pin 22, wherein the second fixing pin 22 axially penetrates the second rotor body 7 so that a rotation of the second rotor body 7 causes a rotation of the second stop disc 15.

The first stop disc 17 further has a plurality of first slot-like access openings 26, through which one of the second fixing pins 22 passes. The first access openings 26 are designed such that the second fixing pins 22 do not restrict a relative rotation of the first stop disc 17 to the second stop disc 15. The same applies similarly to the second stop disc 15, which also has a plurality of second slot-like access openings 25, through which one of the first fixing pins 24 passes, and the second access openings 25 are also designed such that the first fixing pins 24 do not restrict a relative rotation of the first stop disc 17 to the second stop disc 15.

The first fixing pins 24 and the second fixing pins 22 are each designed as screws. The screws are preferably identical.

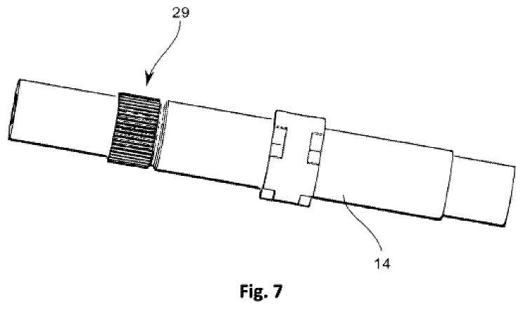

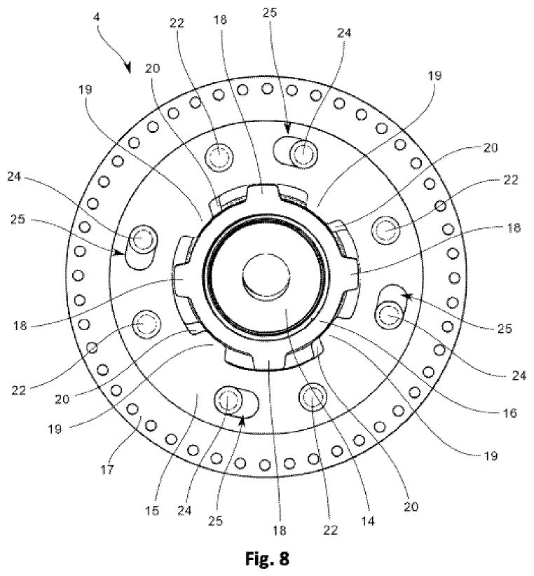

From the overview of FIGS. 6 and 7, it can be seen that the connection between the rotor shaft 14 and the hub 16 for conjoint rotation is formed by means of FIG. 8 shows the rotor 4 in a field-attenuated, neutral position, without any torque acting between the rotor bodies 5, 7. It is clear to see that, in this operating situation, the hub teeth 18 do not create a stop with the first stop disc 17 and the second stop disc 15. FIG. 9 shows the rotor 4 in a field-strengthened, tensile position. In this case, the rotor bodies 5, 7 and the stop discs 15, 17 assigned thereto are then rotated relative to one another until the hub teeth 18 with the teeth 19, 20 of the stop discs 15, 17 form a first stop 12, which, viewed from the hub teeth 18, lies on the counterclockwise flank of the hub teeth 18. FIG. 10 shows the rotor 4 in a field-strengthened, thrust-loaded position, in which the rotor bodies 5, 7 and the stop discs 15, 17 assigned thereto are then rotated relative to one another until the hub teeth 18 with the teeth 19, 20 of the stop discs 15, 17 form a first stop 13, which, viewed from the hub teeth 18, lies on the clockwise flank of the hub teeth 18.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### LIST OF REFERENCE SYMBOLS

1 Electric machine
2 Stator
3 Air gap
4 Rotor
5 Rotor body
6 Permanent magnets
7 Rotor body
8 Permanent magnets
9 Torsional stiffness mechanism
10 Axis of rotation
11 Field-attenuation mechanism
12 Stop
13 Stop
14 Rotor shaft
15 Stop disc
16 Hub
17 Stop disc
18 Hub teeth
19 Teeth
20 Teeth
21 Fixing openings
22 Fixing pin
23 Fixing openings
24 Fixing pin
25 Access openings
26 Access openings
29 Spline

1. A rotor for an electric machine use within comprising:
at least a first rotor body with a first group of permanent magnets and a second rotor body with a second group of permanent magnets, wherein the first rotor body and the second rotor body can be rotated relative to one another about a common axis of rotation, against the effect of a first torsional stiffness mechanism, by a mechanical field-attenuation mechanism, wherein the field-attenuation mechanism has a first mechanical stop which limits the rotation of the two rotor bodies relative to one another in a first circumferential direction, and a second mechanical stop which limits the rotation of the two rotor bodies, relative to one another in a second circumferential direction, wherein
the field-attenuation mechanism has a hub which is coupled to a rotor shaft of the rotor for conjoint rotation, wherein the first rotor body is coupled to a first annular stop disc and the second rotor body is coupled to a second annular stop disc, and both the first stop disc and the second stop disc are positioned at an end of the first rotor body that points out of the rotor.

2. The rotor according to claim 1,
wherein
the hub has a plurality of hub teeth projecting outwards in a radial direction, which form at least one of the first mechanical stop with the first stop disc or the second mechanical stop with the second stop disc.

3. The rotor according to claim 2, wherein at least one of
the first stop disc has a plurality of first teeth projecting inwards in the a radial direction, which together with at least one of the hub teeth form the first mechanical stop or the second stop disc has a plurality of second teeth projecting inwards in the radial direction, which together with at least one of the hub teeth form the second mechanical stop.

4. The rotor according to claim 3,
wherein at least one of
the first stop disc has a plurality of first fixing openings, each of which is penetrated by a first fixing pin, wherein the first fixing pin axially penetrates the first rotor body so that a rotation of the first rotor body causes a rotation of the first stop disc
or
the second stop disc has a plurality of second fixing openings, each of which is penetrated by a second fixing pin, wherein the second fixing pin axially penetrates the second rotor body so that a rotation of the second rotor body causes a rotation of the second stop disc.

5. The rotor according to claim 4,
wherein at least one of
the first stop disc has a plurality of first access openings through which the second fixing pins passes, and the first access openings are configured such that the second fixing pin does not restrict a relative rotation of the first stop disc to the second stop disc,
or
the second stop disc has a plurality of second access openings through which the first fixing pin passes, and the second access openings are configured such that the first fixing pin does not restrict a relative rotation of the first stop disc to the second stop disc.

6. The rotor according to claim 1, wherein
a connection between the rotor shaft and the hub for conjoint rotation is formed by means of a spline.

7. The rotor according to claim 1, wherein
the hub is arranged axially outside the first rotor body and the second rotor body on the rotor shaft.

8. The rotor according claim 1, wherein at least one of the
the first fixing pin or the second fixing pin comprises screw.

9. An electric machine for a drive train of a hybrid-electric or fully electric motor vehicle, comprising: a rotor having at least a first rotor body with a first group of permanent magnets and a second rotor body with a second group of permanent magnets, wherein the first rotor body and the second rotor body can be rotated relative to one another about a common axis of rotation, against the effect of a first torsional stiffness mechanism, by a mechanical field-attenuation mechanism, wherein the field-attenuation mechanism has a first mechanical stop which limits the rotation of the two rotor bodies relative to one another in a first circumferential direction, and a second mechanical stop which limits the rotation of the two rotor bodies relative to one another in a second circumferential direction, wherein the field-attenuation mechanism has a hub which is coupled to a rotor shaft of the rotor for conjoint rotation, wherein the first rotor body is coupled to a first annular stop disc and the second rotor body is coupled to a second annular stop disc, and both the first stop disc and the second stop disc are positioned at an end of the first rotor body that points out of the rotor.

10. A kit-of-parts for forming a field-attenuation mechanism of a rotor of an electric machine, comprising:
a hub which can be coupled to a rotor shaft of the rotor of the electric machine for conjoint rotation,
a first annular stop disc which can be coupled to a first rotor body of the rotor and
a second annular stop disc which can be coupled to a second rotor body of the rotor,
wherein both the first stop disc and the second stop disc can be positioned at an end of the first rotor body that points out of the rotor, wherein a first mechanical stop can be formed between the hub and the first stop disc and a second mechanical stop can be formed between the hub and the second stop disc.

11. The electric machine according to claim 9, wherein the hub has a plurality of hub teeth projecting outwards in a radial direction, which form at least one of the first mechanical stop with the first stop disc or the second mechanical stop with the second stop disc.

12. The electric machine according to claim 11, wherein the first stop disc has a plurality of first teeth projecting inwards in a radial direction, which together with at least one of the hub teeth form the first mechanical stop or the second stop disc has a plurality of second teeth projecting inwards in the radial direction, which together with at least one of the hub teeth form the second mechanical stop.

13. The electric machine according to claim 9, wherein at least one of the first stop disc has a plurality of first fixing openings, each of which is penetrated by a first fixing pin, wherein the first fixing pins axially penetrate the first rotor body so that a rotation of the first rotor body causes a rotation of the first stop disc, or the second stop disc has a plurality of second fixing openings, each of which is penetrated by a second fixing pin, wherein the second fixing pins axially penetrate the second rotor body so that a rotation of the second rotor body causes a rotation of the second stop disc.

14. The electric machine according to claim 13, wherein at least one of the first stop disc has a plurality of first access openings through which the second fixing pins pass, and the first access openings are configured such that the second fixing pins do not restrict a relative rotation of the first stop disc to the second stop disc or the second stop disc has a plurality of second access openings through which the first fixing pins pass, and the second access openings are configured such that the first fixing pins do not restrict a relative rotation of the first stop disc to the second stop disc.

15. The electric machine according to claim 9, wherein a connection between the rotor shaft and the hub for conjoint rotation is formed by a spline.

16. The electric machine according to claim 9, wherein the hub is arranged axially outside the first rotor body and the second rotor body on the rotor shaft.

17. The electric machine according claim 9, wherein at least one of the first fixing pins or the second fixing pins comprises a screw.
